(19) United States
(12) Patent Application Publication
(10) Pub. No.: US 2008/0027600 A1
(43) Pub. Date: Jan. 31, 2008

(54) Systems and methods for intelligently establishing communication

(76) Inventors: Paul W. Bierdeman, East Peoria, IL (US); Wayne D. Brandt, Morton, IL (US); Alan L. Ferguson, San Jose, CA (US); Daniel C. Wood, East Peoria, IL (US); Robert F. Schulz, Dunlap, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/495,750

(22) Filed: Jul. 31, 2006

(51) Int. Cl. G01C 22/00

(52) U.S. Cl. 701/24

(57) ABSTRACT

Systems and methods are provided for intelligently establishing a communication session between a machine and off-board system. In one implementation, a system for intelligently establishes a communication session. The system includes a machine communicating with a network and an off-board system that transmits a request for data from the machine over the network. The system also includes a communication server in communication with the machine and the off-board system via the network. The communication server determines whether hardware and a network connection to transmit the requested data and are available on-board the machine and determines whether the off-board system has authority to receive the requested data.

### TECHNICAL FIELD

The present disclosure relates generally to establishing a communication session, and more particularly, to systems and methods for-intelligently establishing a communication session between a machine and an off-board system.

### BACKGROUND

A modern machine (e.g., a fixed and mobile commercial machine, such as a construction machine, fixed engine system, marine-based machine, etc.) includes an on-board system and associated machine control modules. An on-board system typically includes many different modules connected to various types of communication links. These links may be proprietary and non-proprietary, such as manufacturer-based data links and communication paths based on known industry standards (e.g., J1939, RS232, RP 1210, RS422, RS485, MODBUS, CAN, etc.). The modules may monitor and/or control one or more components and/or operations of the machine. The control modules may also receive data from and transmit data to external systems using the communication links.

Currently, there exist many types of customized communications solutions that handle the various protocols that are required to transmit data off-board a machine. For example, a machine may use one protocol to communicate with one off-board system and a second protocol to communicate with a second off-board system. Furthermore, a machine may use dedicated hardware to communicate in certain protocols. Accordingly, a particular protocol may require dedicated use of a physical connection, such as a data port, limiting the ability of a machine to communicate with certain off-board systems. Thus, prior to transmitting data to an off-board system, it is necessary to ensure that the machine is communicating in an appropriate protocol.

One method of automatically configuring a device for connection with an external wireless network is described in U.S. Pat. No. 6,975,857 B2 (the '857 patent), which issued to Tourrilhes et al. on Dec. 13, 2005. The '857 patent describes automatic configuration of a communication interface of a device such that the device can automatically establish wireless communication with an external wireless network without any user intervention.

Although the system of the '857 patent may automatically configure a device for communication with an external wireless network, the system nevertheless has several disadvantages. For example, the system does not provide an ability to intelligently establish a communication session with a machine based on the requirements of a particular off-board system. For example, when establishing a communication session between a machine and off-board system, it is necessary to determine whether appropriate hardware, network. connections, data transmission rates, and security measures are available prior to transmitting data. Furthermore, due to the variety of different off-board systems and protocols, separate procedures are often needed for establishing a communication session on a per off-board system basis.

The disclosed system and methods are directed to overcoming one or more of the problems set forth above.

### SUMMARY OF THE INVENTION

In one aspect, the present disclosure is directed to a system for intelligently establishing a communication session. The system may include a machine communicating with a network and an off-board system that transmits a request for data from the machine over the network. The system may also include a communication server in communication with the machine and the off-board system via the network. The communication. server may receive the request, determine whether hardware and a network connection to transmit the requested data are available on-board the machine, and determine whether the off-board system has authority to receive the requested data.

In another aspect, the present disclosure is directed to a method for intelligently establishing a communication session. The method may include receiving, over a network, a request from an off-board system for data from a machine. The method may also include determining whether hardware to transmit the requested data is available on-board the machine, whether a network connection to transmit the requested data is available from the machine, and whether the off-board system has authority to receive the requested data.

It is to be understood that both the foregoing general description and the following detailed description are exemplary and explanatory only and are not restrictive of the invention or embodiments thereof, as claimed.

### BRIEF DESCRIPTION OF THE DRAWINGS

The accompanying drawings, which are incorporated in and constitute a part of this disclosure, illustrate various embodiments. In the drawings:

FIG. 1 illustrates an exemplary environment for establishing communication with a machine, consistent with an embodiment;

FIG. 2 shows an exemplary block diagram of an on-board system of a machine, consistent with an embodiment;

FIG. 3 shows an exemplary system for intelligently establishing communication between a machine and off-board system, consistent with an embodiment;

FIG. 4 shows an exemplary software architecture for intelligently establishing a communication session between a machine and an off-board system, consistent with an embodiment; and

FIG. 5 is a flow diagram of an exemplary method for intelligently establishing a communication session between a machine and an off-board system, consistent with an embodiment.

### DETAILED DESCRIPTION

Systems and methods disclosed herein intelligently establish a communication session between a machine and off-board system. For example, an off-board system may transmit a request for information that is targeted for a machine component. In response, a process executing on-board or off-board-the machine intercepts the request and performs a series of procedural checks to determine if, how, and when to establish communication between the machine and the off-board system. In one implementation, the process may be software located on an on-board machine component. In another implementation, the process may be an off-board intermediary system that receives the request and performs the process.

Furthermore, the disclosed systems and methods may process the request by performing a series of evaluations and verifications prior to establishing communication. For example, an off-board system may issue a request for data and an on-board machine component may receive the request. The on-board machine component may execute a communication establishment process that includes one or more process steps.

For example, the process may include determining whether certain hardware (e.g., radio, target Engine Control Module (ECM), etc.) is available on-board the machine to collect the data and transmit the data to the off-board system. The process may also include determining whether a certain network connection (e.g. cellular, satellite, 802.11, USB, serial, on-board data links, etc.) is available to transmit the data. The process may include determining whether the off-board system requesting the data has the appropriate authority to receive the requested data, i.e., the off-board system-may be authenticated. The process may include determining whether any latency-issues exist that may effect the transmission of the data to the off-board system. For example, the process may include determining whether there is sufficient bandwidth available for the needed network connection. The process may include executing a security process to determine whether appropriate security features are confirmed (e.g., requestor authentication, data security, and other firewall types of processes). Furthermore, the process may check for any run-time flags or errors or remote/local connections as well as verify the operational status of the machine.

After one or more of the above steps are taken and completed, the process may format a response message for communication off-board the machine using a standard off-board data link of the machine, such as an Ethernet port. For example, an Ethernet port may deliver a message to a radio device on-board the machine that transmits the response over one of many different networks (e.g., cellular, satellite, 802.11, etc.).

Reference will now be made in detail to exemplary embodiments, which are illustrated in the accompanying drawings. Wherever possible, the same reference numbers will be used throughout the drawings to refer to the same or like parts.

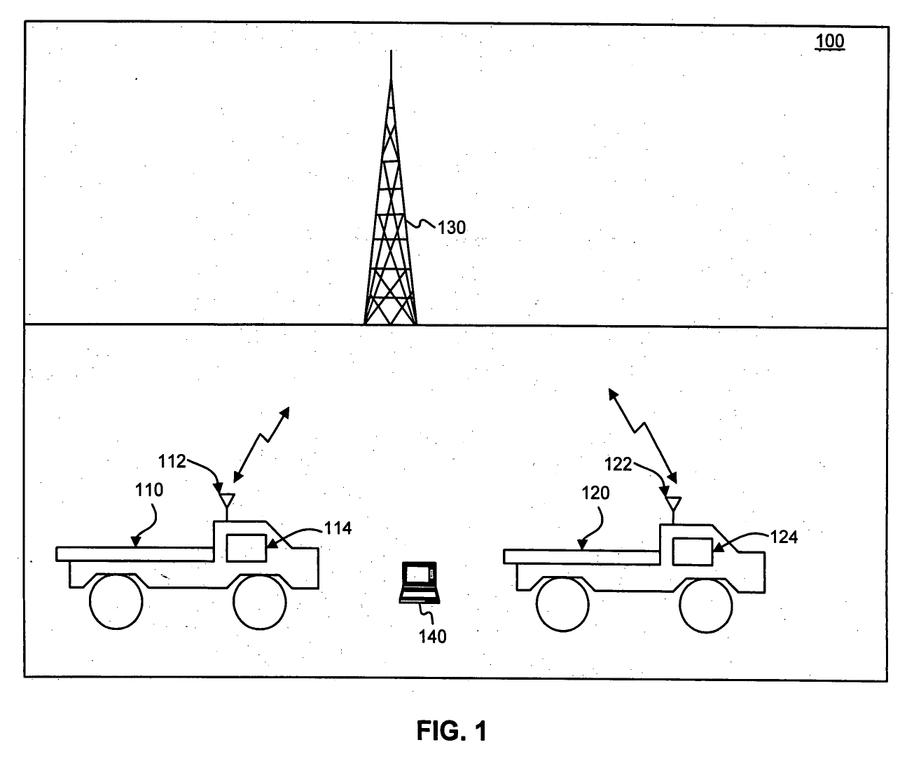

FIG. 1 illustrates an exemplary environment 100 for establishing communication with a machine, consistent with one disclosed embodiment. As shown in FIG. 1, environment 100 may include machine 110, machine 120, radio tower 130, and laptop 140.

The term “machine” refers to a fixed or mobile machine that performs some type of operation associated with a particular industry, such as mining, construction, farming, etc., and operates between or within work environments (e.g., construction site, mine site, power plants, etc.). A non-limiting example of a fixed machine includes an engine system operating in a plant or off-shore environment (e.g., off-shore drilling platform). Non-limiting examples of mobile machines include commercial machines, such as trucks, cranes, earth moving machines, mining machines, backhoes, material handling equipment, farming equipment, marine vessels, aircraft, and any type of movable machine that operates in a work environment. As shown in FIG. 1, machine 110 and machine 120 are hauler-type machines. The type of machine illustrated in FIG. 1 is exemplary and not intended to be limiting. It is contemplated by the disclosed embodiments that environment 100 may implement any number of different types of machines.

Environment 100 also includes laptop 140, which may communicate with radio tower 130, machine 110, and machine 120. For example, laptop 140 may communicate wirelessly with radio tower 130, machine 110, and machine 120. Laptop 140 may also communicate directly via a wirelink to machine 110 and machine 120.

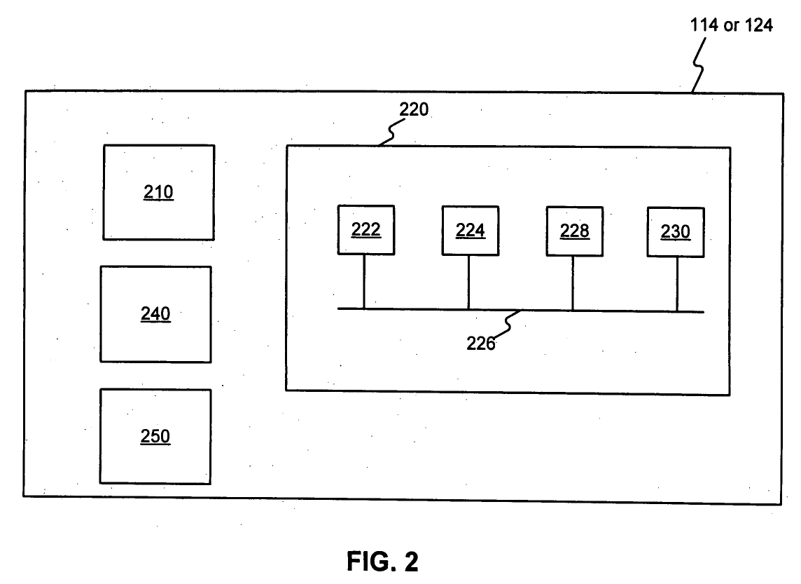

Machines 110 and 120 may include on-board systems 114 and 124, respectively. On-board systems 114 and 124 may provide a combination of hardware and software components for processing and communicating data. On-board systems 114 and 124 are discussed below in further detail with regard to FIG. 2.

Furthermore, machine 110 may include antenna 112 and machine 120 may include antenna 122. Antenna 112 and antenna 122 may communication via radio wave transmission with radio tower 130, as well as with laptop 140. Machine 110 and machine 120 may also communicate with each other via radio wave transmission via antenna 112 and antenna 122. Communication between machines 110, 120, radio tower 130, and laptop 140 may occur according to any appropriate communication protocol. Moreover, machine 110 and/or machine 120 may communicate with any other appropriate device that connects directly to machine 110 and/or machine 120 via a data port. Although only a specific number of machines are shown, environment 100 may include any number and types of such machines.

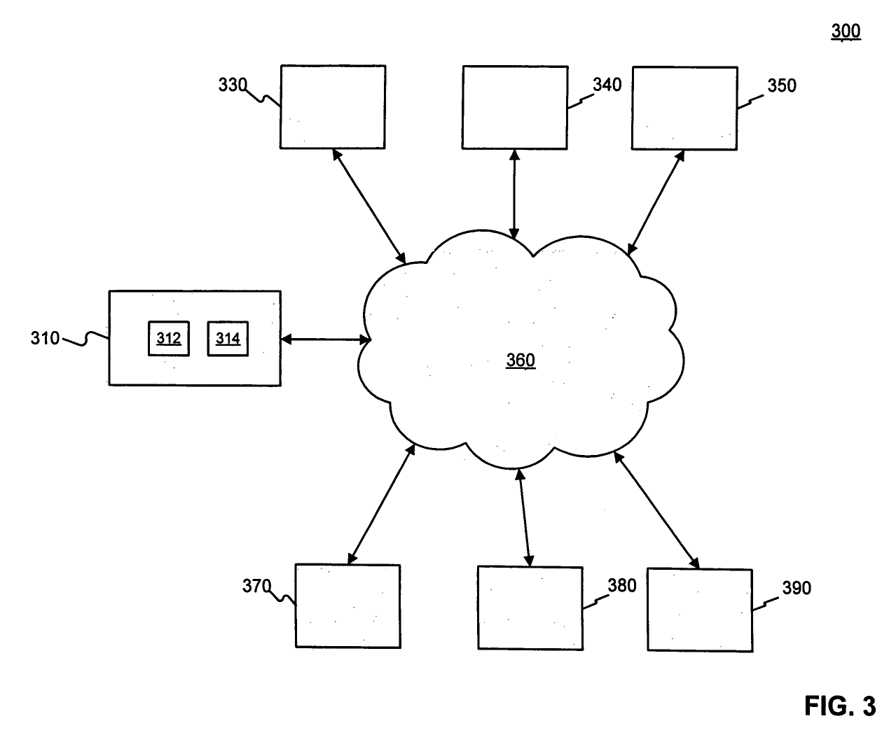

Communication between machines 110 and 120, radio tower 130, and laptop 140 may include transmitting and/or receiving data from one or more off-board systems available over a network via tower 130. For example, machine 110 may communicate with radio tower 130 via antenna 112. Machine 120 may communicate with radio tower 130 via laptop 140, which may connect via a direct data link or a wireless data link to machine 120. As yet another alternative, machine 120 may connect directly to an off-board system via a direct data link. An exemplary network is discussed below in further detail with regard to FIG. 3.

An “off-board system” may represent a system that is located remote from machines 110 and 120. An off-board system may be a system that connects to machines 110 and 120 through wireline or wireless data links. Further, an off-board system may be a computer system including known computing components, such as one or-more processors, software, a display, and interface devices that operate collectively to perform one or more processes. Alternatively, or additionally, an off-board system may include one or more communication devices that facilitate the transmission of data to and from machines 110 and 120. In certain embodiments, an off-board system may be another machine remotely located from machines 110 and l20.

For example, machine 110 may communicate with an off-board system via radio tower 130. Radio tower 130 may then, in turn, relay communications via a network to an off-board system. Furthermore, communications from machine 110 may be relayed to a communication server, as discussed below with regard to FIG. 3, that performs functionality for intelligently establishing communication with an off-board system. In an alternative embodiment, machine 110 may instead perform the functionality provided by the communication server. In yet another embodiment, machine 110 may communicate with radio tower 130 via laptop 140 via wirelink or wireless communication.

FIG. 2 shows an exemplary block diagram of on-board system 114 of machine 110, consistent with one disclosed embodiment. On-board system 114 may represent a system of one or more on-board modules, interface systems, data links, and other types of components that perform machine processes within machine 110. As shown in FIG. 2, on-board system 114 may include a communication module 210, an interface control system 220, and on-board modules 240 and 250.

Communication module 210 represents one or more devices that is configured to facilitate communications between machine 110 and an off-board system. Communication module 210 may include hardware and/or software that enables the module to send and/or receive data messages through wireline or wireless communications. Communication module 210 may also interact with antenna 112 for facilitating wireless communications with a remote off-board system. Further, off-board systems may send and receive data messages to and from communication module 210. Wireless communications may include satellite, cellular, infrared, and any other type of wireless communication that enables machine 110 to wirelessly exchange information with an off-board system. For example, machine 110 may wirelessly exchange information with radio tower 130, machine 120, or laptop 140.

Interface control system 220 may include various computing components used to perform certain functions consistent with the requirements of a particular embodiment. To do so, interface control system 220 may include one or more processors and memory-devices. For example, interface control system 220 may include a digital core that includes the logic and processing components used by interface control system 220 to perform interface, communications, software update functionalities, and software driver selection. In one embodiment, the digital core may include one or more processors and internal memories. The memories may represent one or more devices that temporarily store data, instructions, and executable code, or any combination thereof, used by a processor. Further, the memories may represent one or more memory devices that store data temporarily during operation of interface control system 220, such as a cache memory, register device, buffer, queuing memory device, and any type of memory device that maintains information. The internal memory used by interface control system 220 may be any type of memory device, such as flash memory, Static Random Access Memory (SRAM), and battery backed non-volatile memory devices.

In operation, the digital core may execute program code to facilitate communications between on-board modules and/or off-board systems. In one embodiment, interface control system 220 may include software that performs protocol conversion operations for converting information associated with one type of data link to another. The conversion operations may include protocol translation and tunneling features.

Interface control system 220 may include a processor 222, a memory 224 (e.g., RAM), and a bus 226, which couples processor 222 and memory 224 to a storage system 228 and a communication interface 230. Storage system 228 may include one or more memory devices (e.g. RAM, ROM NV RAM, magnetic disks, optical storage disks, etc.). Additionally, storage system 228 may include memory controller components, such as an I/0 controller that facilitates access to and from storage system 228.

Communication interface 230 may be one or more interface components (e.g., software, hardware, or a combination thereof) that transmits and receives information from and to interface control system 220. In addition to performing information transfer between machine 110 and off-board data links (e.g., wired and/or wireless networks), interface control system 220 may be configured to perform one or more remote machine control processes. For example, interface control system 220 may allow a first machine (e.g., machine 110) to provide communications and remote control of one or more second machines (e.g., machine 120). Further, interface control system 220 may be configured to accept and process remote communication and control data received from one or more remote machines.

On-board modules 240 and 250 may represent any type of component operating in a machine that controls or is controlled by other components or sub-components. For example, an on-board module may be an operator display device, an Engine Control Module (ECM), a power system control module, a Global Positioning System (GPS) interface device, an attachment interface that connects one or more sub-components, and any other type of device that machines 110 and 120 may implement to facilitate operations of the machines during run time or non-run time conditions (i.e., machine engine running or not running, respectively). Although two on-board modules are shown in FIG. 2 for purposes of illustration, one of ordinary skill in the art will recognize that the number of modules may vary depending upon the functionality provided by a particular on-board system.

FIG. 3 shows an exemplary system 300 for intelligently establishing communication between a machine and off-board system, consistent with one disclosed embodiment. As shown in system 300, communication server 310, terminals 330, 340, and 350, and off-board systems 370, 380, and 390 are connected to a network 360. One of skill in the art will appreciate that although three terminals and three off-board systems are depicted in FIG. 3, any number of terminals and off-board systems may be provided. Furthermore, one of ordinary skill in the art will recognize that functions provided by one or more components of system 300 may be combined.

Network 360 provides communications between the various entities in system 300, such as communication server 310, terminals 330-350, and off-board systems 370-390. In addition, communication server 310, terminals 330-30, and off-board systems 370-390 may access legacy systems (not shown) via network 360, or may directly access legacy systems and/or databases. Network 360 may be a shared, public, or private network, may encompass a wide area or local area, and may be implemented through any suitable combination of wired and/or wireless communication networks. Furthermore, network 360 may comprise a local area network (LAN), a wide area network (WAN), an intranet, or the Internet.

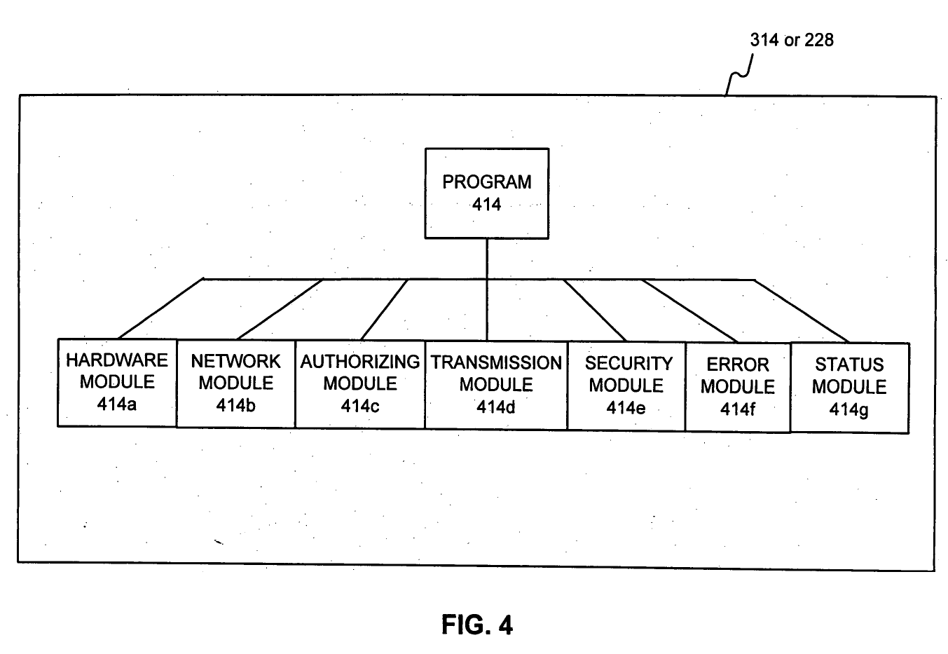

Communication server 310 may comprise a general purpose computer (e.g., a personal computer, network computer, server, or mainframe computer) having a processor 312 that may be selectively activated or reconfigured by a computer program. Communication server 310 may also be implemented in a distributed network. Alternatively, communication server 310 may be specially constructed for carrying-out methods consistent with the disclosed embodiment. Furthermore, communication server 310 may include a data storage 314 for storing program modules that intelligently establish a communication session between a machine and an off-board system. Program modules are discussed in further detail with respect to FIG. 4.

Terminals 330-350 may be any type device for communicating with communication server 310 and/or off-board systems 370-390 over network 360. Furthermore, terminals 330-350 may communicate directly or indirectly with machines 110 and 120 via wirelink or wireless networks. For example,.terminals 330-350 may be personal computers, handheld devices, or any-other appropriate computing platform or device capable of exchanging data with network 360 and machines 110 and 120. Terminals 330-350 may each include a processor, a data storage, and an interface card for direct connection to a port of machines 110 and 120. Furthermore, terminals 330-350 may be radio towers in communication with one or more other radio towers comprising a wireless network. For example, terminal 330 may wirelessly communicate with radio tower 130, and in turn, machine 110.

Off-board systems 370-390 may represent one or more computing systems associated with an entity, such as a manufacturer, dealer, retailer, owner, project site manager, a department of a business entity (e.g., service center, operations support center, logistics center, etc.), or any other type of entity that generates, maintains, sends, and/or receives information associated with machines 110 and 120. Off-board systems 370-390 may include one or more computer systems, such as a workstation, personal digital assistant, laptop, mainframe, etc. Off-board systems 370-390 may include Web browser software that requests and receives data from a server when executed by a processor and displays content to a user operating the system.

Off-board systems 370-390 may include one or more portable, or fixed, service systems that perform diagnostics and/or service operations that include receiving and sending messages to machine 110 and/or machine 120. To do so, off-board systems 330-350 may connect directly or indirectly with machines 110 and 120. For example, off-board system 330 may be an electronic testing device that communicates through wireless communication mediums via network 360 with radio tower 130, and in turn, machine 110.

Other examples of off-board systems 370-390 include an electronic technician (ET) system for monitoring a machine for maintenance purposes; an equipment manager (EM) system for maintaining a database including data from other systems; a vital information management system (VIMS) and PC system that collects vital information from a machine and that can be downloaded from the machine in a batch mode to a lap top (e.g., a Minestar system for mining operations that is used for asset management and provides an interface between a machine and a mining office); an ACCU Grade Office system that provides an operator assist to perform earth moving projects (e.g., providing an overlay showing dirt targeted for removal); operator assist systems that control a machine blade and/or steer a machine; and industrial control systems that collect data regarding engines (e.g, sensor information and indicators such as speed, revolutions per minute (RPM), etc.).

Terminals 330-350 may execute program modules that provide one or more graphical user interfaces (GUIs) for interacting with network resources to transmit and/or receive data from machines 110 and 120. Users may access data provided by machines 110 and 120 via network 360 through a web browser or software application running on, for example, any one of terminals 330-350. For example, a web portal may include options for allowing a user to log onto a secure site provided by communication server 310 by supplying credentials, such as a username and a password. Once logged onto the site, the web portal may display a series of screens prompting the user to make various selections for interacting with machine 110 and/or machine 120. Since some disclosed embodiments may be implemented using an HTTPS (hypertext transfer protocol secure) environment, data transfer over a network, such as the Internet, may be done in a secure fashion.

In some embodiments, a web interface generated by communication server 310 that is displayed to users of terminals 330-350 may provide various options. For example, a user may use terminal 340 to intelligently establish a communication session between machine 110 and off-board system 330, which may provide a diagnostic tool. In this example, off-board system 330 may request information from machine 110. A process executing at communication server 310 may intercept the request and perform a series of procedural checks to determine if, how, and when to establish communication between machine 110 and off-board system 330.

In another implementation, instead of using communication server 310 to perform the procedural checks, the process may be performed by on-board system 114 of machine 110. For example, the functionality implemented by communication server 310 may also be provided by on-board system 114. In such an embodiment, on-board system 114 may intelligently establish a communication session between machine-110 and off-board system 330.

FIG. 4 shows an exemplary software architecture for intelligently establishing a communication session between a machine and an off-board system, consistent with an embodiment of the present invention. The software architecture may be stored in data storage 314 of communication server 310 as shown in FIG. 3 or data storage system 228 of machine 110, as shown in FIG. 2, for example.

In one embodiment, data storage 314 or data storage 228 stores instructions of program 414, which when executed, perform a process to intelligently establish communication between a machine and an off-board system. To intelligently establish communication, program 414 may include instructions in the form of one or more software modules 414a-414g. Software modules 414a-414g may be written using any known programming language, such as C++ XML, etc., and may include hardware module 414a, network module 414b, authorizing module 414c, transmission module 414d, security module 414e, error module 414f, and status module 414g.

Hardware module 414a may determine whether certain hardware (e.g., radio, target ECM, antenna, etc.) is available on-board a machine. For example, hardware module 414a may determine whether a machine has sufficient hardware capabilities to collect requested data and transmit the requested data to an off-board system.

Network module 414b may determine whether an appropriate network connection (e.g. cellular, satellite, 802.11, USB, serial, on-board data links, etc.) is available to transmit the requested data from the machine to the off-board system. For example, network module 414b may determine whether a machine has an available data link to network 360.

Authorizing module 414c may determine whether the off-board system requesting the data has the appropriate authority to receive the requested data. For example, authorizing module 414c may verify credentials supplied by the off-board system in order to confirm the identity of the off-board and verify that the off-board system is authorized to receive the requested data.

Transmission module 414d may determine whether any latency issues exist that may effect the transmission of the data from the-machine to the off-board system. For example, transmission module 414d may determine whether there is sufficient bandwidth available for the needed network connection. For some communications, delays in receiving data may affect performance (i.e., remote steering applications requesting status information, for example, and latency issues could impact safety.

Security module 414e may execute a security process to determine whether appropriate security features are confirmed (e.g., data security, and other firewall types of processes). For example, security module 414e may encrypt data and verify the security of an off-board system connection prior to data transmission.

Error module 414f may check for any-run-time flags or errors and/or any remote/local connection errors. For example, error module 414f may discover and handle any errors in retrieving or formatting the data for transmission. Furthermore, error module 414f may determine whether any remote or local connections in network 360 have become unavailable.

Status module 414g may verify the operation status of the machine. For example, status module 414g may determine an appropriate time to transmit the requested data without interfering with processes required of the machine.

Although program modules 414a-414f have been described above as being separate modules, one of ordinary skill in the art will recognize that functionalities provided by one or more modules may be combined. Furthermore, one of ordinary skill in the art will recognize that program 414 may reside in communication server 310, machines 110 and 120, laptop 140, or in any device connected directly or wirelessly to machine 110 and/or machine 120.

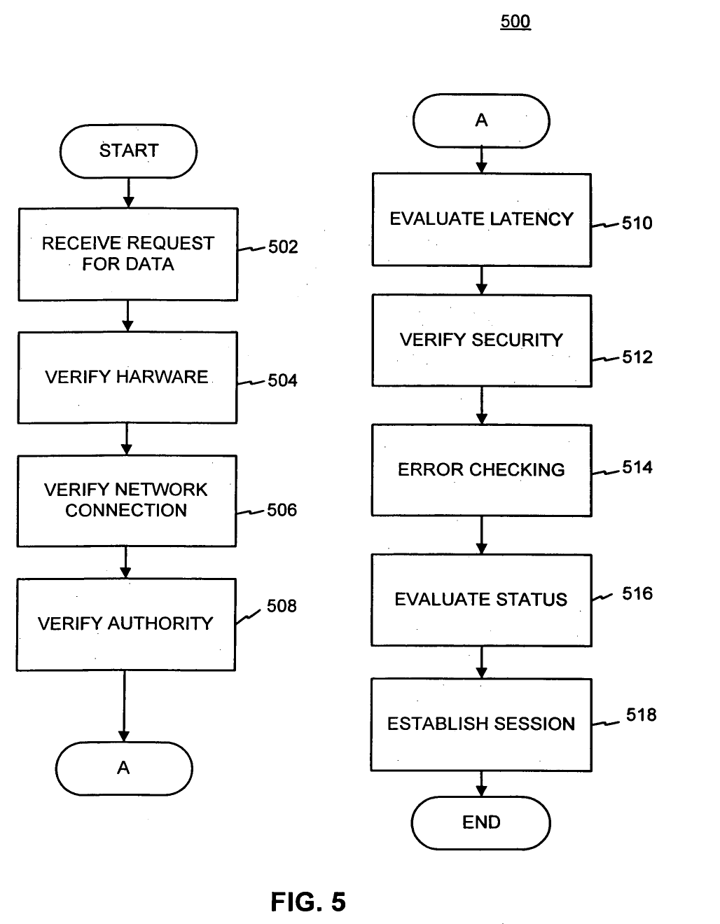

Referring now to FIG. 5, a flow diagram 500 is provided of an exemplary method for intelligently establishing a communication session between a machine and an off-board system. For example, the method may implement processes according to program modules 414a-414f.

At the start of the process, in step 502, communication server 310 may receive a request over network 360 from off-board system 370. For example, off-board system 370 may request data from machine 110 and communication server 310 may communicate with machine 110 over network 360. In turn, machine 110 may communicate via antenna 112 to radio tower 130. Radio tower 130 may be in communication with one or more radio towers in communication with network 360. The process then proceeds to step 504.

In step 504, communication server 310 may determine whether appropriate hardware is available to transmit the requested data from machine 110. For example, hardware module 414a may determine whether machine 110 has sufficient hardware capabilities to collect requested data and transmit the requested data to an off-board system. The required hardware may be identified based on the protocol and format of the request received from off-board system. 370. The process then proceeds to step 506.

In step 506, communication server 310 may determine whether an appropriate network connection (e.g. cellular, satellite, 802.11, USB, serial, on-board data links, etc.) is available to transmit the request data from the machine to the off-board system. For example, network module 414b may determine whether a machine has an available data link to network 360 in order to transmit the requested data. Should the data link be unavailable, machine 110 may transmit a message back to communication server 310 indicating status information. The process then proceeds to step 508.

In step 508, communication server 310 may determine whether the off-board system requesting the data has the appropriate authority to receive the requested data. For example, authorizing module 414c may verify credentials supplied by off-board system 370 in order to confirm the identity of off-board system 370 and verify that off-board system 370 is authorized to receive the requested data. If off-board system 370 is not authorized to receive the data, an appropriate message may be transmitted to communication server 310. The process then proceeds to step 510.

In step 510, communication server 310 may determine whether any latency issues exist that may effect the transmission of the data from the machine to the off-board system. For example, transmission module 414d may determine whether there is sufficient bandwidth available for the needed network connection. The process then proceeds to step 512.

In step 512, communication server 310 may determine whether appropriate security features e.g., data security, and other firewall types of processes) are implemented by off-board system. 370. For example, security module 414e may encrypt data and verify the security of off-board system 370 prior to data transmission. The process then proceeds to step 514.

In step 514, communication server 310 may check for any run-time flags or errors and/or any remote/local connection errors in network 360. For example, error module 414f may discover and handle any errors in retrieving or formatting the data for transmission. Furthermore, error module 414f may determine whether any remote or local connections have become unavailable, such as radio towers required to transmit data to network 360. The process then proceeds to step 516.

In step 516, communication server 310 may verify the operation status of the machine. For example, status module 414g may determine an appropriate time to transmit the requested data without interfering with processes required of the machine. The process then proceeds to step 518.

Turning to step 518, once the above procedural checks and verifications have been performed, communication server 310 may establish a communication session between off-board system 370 according to the appropriate protocol and direct machine 110 to transmit the requested data via the appropriate hardware. For example, machine 110 may transmit the data using a particular hardware device and network connection determined in one or more of the appropriate steps. The process then ends.

Alternatively, in situations where off-board system 370 does not have authority to receive the data, for example, or the particular hardware device and/or network connection is unavailable from the machine, an appropriate message may be transmitted to off-board system 330.

Furthermore, as one of ordinary skill in the art will appreciate, on or more of steps 504-514 may be optional and may be omitted from implementations in certain embodiments. Furthermore, in an alternative implementation, in step 502, the request from off-board system 370 may be transmitted over network 360 and received by on-board system 114. For example, in such an alternative implementation, one or more of steps 502-518 may be performed by on-board system 114 instead of communication server 310.

### INDUSTRIAL APPLICABILITY

Methods and systems consistent with the disclosed embodiments enable a machine to intelligently establish a communication session with an off-board system. Further, these embodiments enable the machine to interact with a network and determine whether appropriate hardware and network connections are available for the off-board system to interact with the machine. To facilitate the processes performed by the disclosed embodiments, machines may communicate via direct wireline or indirectly via wireless communication. The selected operations disclosed above may be performed centrally by a service, such as a communication server, or may incorporated directly into the software of an on-board system of a machine.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations include software, but systems and methods consistent with the present invention may be implemented as a combination of, hardware and software or in hardware alone. Examples of hardware include computing or processing systems, including personal computers, servers, laptops, mainframes, microprocessors and the like. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Computer programs based on the written description and methods of this invention are within the skill of an experienced developer. The various programs or program modules can be created using any of the techniques known to one skilled in the art or can be designed in connection with existing software. For example, program sections or program modules can be designed in or by means of Java, C++, HTML, XML, or HTML with included Java applets. One or more of such software sections or modules can be integrated into a computer system or browser software.

Moreover, while illustrative embodiments of the invention have been described herein, the scope of the invention includes any and all embodiments having equivalent elements, modifications, omissions, combinations (e.g., of aspects across various embodiments), adaptations and/or alterations as would be appreciated by those in the art based on the present disclosure. Further, the steps of the disclosed methods may be modified in any manner, including by reordering steps and/or inserting or deleting steps, without departing from the principles of the invention. It is intended, therefore, that the specification and examples be considered as exemplary only, with a true scope and spirit of the invention being indicated by the following claims and their full scope of equivalents.

What is claimed is:

1. A system for intelligently establishing a communication session, the system comprising:
a machine communicating with a network;
an off-board system that transmits a request for data from the machine over the network; and
a communication server in communication with the machine and the off-board system via the network, wherein the communication server receives the request, determines whether hardware and a network connection to transmit the requested data are available on-board the machine and determines whether the off-board system has authority to receive the requested data.

2. The system of claim 1, wherein the communication server establishes a communication session between the machine and the off-board system when the determined hardware and the determined network connection are available on-board the machine and the off-board system has authority to receive the requested data.

3. The system of claim 2, wherein the communication server determines, prior to establishing the communication session, whether delays may effect transmission between the machine and the off-board system.

4. The system of claim 2, wherein the communication server determines, prior to establishing the communication session, whether security features are implemented by the off-board system.

5. The system of claim 2, wherein the communication server determines, prior to establishing the communication session, whether any run-time flags have occurred or whether a required local connection to the network is unavailable.

6. The system of claim 2, wherein the communication server determines, prior to establishing the communication session, whether to establish the communication session based on an operational status of the machine.

7. The system of claim 2, wherein after the communication session is established, the machine transmits the requested data to the off-board system using the determined hardware and the determined network connection.

8. The system of claim 1, wherein the machine communicates with the network via an antenna.

9. The system of claim 1, wherein the communication server is included on-board the machine.

10. A method for intelligently establishing a communication session, the method comprising:
receiving, over a network, a request from an off-board system for data from a machine;
determining whether hardware to transmit the requested data is available on-board the machine;
determining whether a network connection to transmit the requested data is available from the machine; and
determining whether the off-board system has authority to receive the requested data.

11. The method of claim 10, further including:
establishing a communication session between the machine and the off-board system when the determined hardware and determined network connection are available on-board the machine and the off-board system has authority to receive the requested data.

12. The method of claim 11, further including:
determining, prior to establishing the communication session, whether delays may effect transmission between the machine and the off-board system.

13. The method of claim 11, further including:
determining, prior to establishing the communication session, whether security features are implemented by the off-board system.

14. The method of claim 11, further including:
determining, prior to establishing the communication session, whether any run-time flags have occurred or whether a required local connection to the network is unavailable.

15. The method of claim 11, further including:
determining, prior to establishing the communication session, whether to establish the communication session based on an operational status of the machine.

16. The method of claim 11, further including:
transmitting, by the machine, the requested data to the off-board system using the determined hardware and the determined network connection.

17. The method of claim 10, wherein the machine communicates with the network via an antenna.

18. A computer-readable medium for intelligently establishing a communication session, the computer-readable medium executing program instructions according to a method, the method comprising:
receiving, over a network, a request from an off-board system for data from a machine;
determining whether hardware to transmit the requested data is available on-board the machine;
determining whether a network connection to transmit the requested data is available from the machine; and
determining whether the off-board system has authority to receive the requested data.

19. The computer-readable medium of claim 18, further including:
establishing a communication session between the machine and the off-board system when the determined hardware and determined network connection are available on-board the machine and the off-board system has authority to receive the requested data.

20. The computer-readable medium of claim 18, further including:
transmitting, by the machine, the requested data to the off-board system using the determined hardware and the determined network connection.
